(19) United States
(12) Patent Application Publication
(10) Pub. No.: US 2020/0094548 A1
(43) Pub. Date: Mar. 26, 2020

(54) LIQUID DISCHARGE APPARATUS

(71) Applicants: Kunihiko NISHIOKA, Kanagawa (JP); Yohei OSANAI, Kanagawa (JP); Satoshi NARAI, Kanagawa (JP); Munekazu HIRATA, Tokyo (JP); Masatoshi ISHIDA, Kanagawa (JP); Takayuki ANDOH, Kanagawa (JP); Tomoya FUJII, Kanagawa (JP); Masashi OTA, Kanagawa (JP)

(72) Inventors: Kunihiko NISHIOKA, Kanagawa (JP); Yohei OSANAI, Kanagawa (JP); Satoshi NARAI, Kanagawa (JP); Munekazu HIRATA, Tokyo (JP); Masatoshi ISHIDA, Kanagawa (JP); Takayuki ANDOH, Kanagawa (JP); Tomoya FUJII, Kanagawa (JP); Masashi OTA, Kanagawa (JP)

(73) Assignee: Ricoh Company, Ltd., Tokyo (JP)

(21) Appl. No.: 16/538,280

(22) Filed: Aug. 12, 2019

(30) Foreign Application Priority Data
Sep. 26, 2018 (JP) 2018-180971

(51) Int. Cl. B41J 2/045; B41J 2/14; B41J 3/36; B41J 2/125; B41J 2/365

(52) U.S. Cl. CPC B41J 2/04563; B41J 2/14153; B41J 2/365; B41J 3/36; B41J 2/125; B41J 2/0454

(57) ABSTRACT

A liquid discharge apparatus includes an apparatus body, a liquid discharge head configured to discharge a liquid and be removably attached to the apparatus body, and a temperature detection device configured to detect a temperature of the liquid discharge head. The temperature detection device includes a temperature detector disposed in the apparatus body and configured to be in line contact with the liquid discharge head.

### CROSS-REFERENCE TO RELATED APPLICATION

This patent application is based on and claims priority pursuant to 35 U.S.C. § 119(a) to Japanese Patent Application No. 2018-180971, filed on Sep. 26, 2018, in the Japan Patent Office, the entire disclosure of which is hereby incorporated by reference herein.

### BACKGROUND

### Technical Field

The present disclosure relates to a liquid discharge apparatus.

### Discussion of the Related Art

Conventionally, a liquid discharge apparatus is known that includes a liquid discharge head that is attachable to or detachable from an apparatus body.

For example, a printer (the liquid discharge apparatus) includes a printing head (the liquid discharge head) and a temperature detection device. The printer head is attachable or detachable. The temperature detection device detects the temperature of the printing head.

### SUMMARY

According to an embodiment of this disclosure, a liquid discharge apparatus includes an apparatus body, a liquid discharge head configured to discharge a liquid and be removably attached to the apparatus body, and a temperature detection device configured to detect a temperature of the liquid discharge head. The temperature detection device includes a temperature detector disposed in the apparatus body and configured to be in line contact with the liquid discharge head.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is an exterior perspective view illustrating a handheld printer as viewed from above obliquely according to Embodiment 1;

FIG. 2 is an exterior perspective view of a printer body of the handheld printer illustrated in FIG. 1, in a state in which a cover is removed from the printer body;

FIG. 3 is an exterior perspective view of the printer body in a state in which a spacer is detached, as viewed obliquely from below;

FIG. 4 is a perspective view of the printer body in a state in which a printed image is being formed on a recording medium;

FIG. 5 is a block diagram illustrating a part of an electric circuit of the printer body;

FIG. 6 is an exterior perspective view of the printer body in a state in which the spacer is attached, viewed obliquely from below;

FIG. 7 is a schematic view illustrating the printer body being moved along a curved track in a roller contactless state;

FIG. 8 is an exterior perspective view of a printer body with an upper unit open;

FIG. 9 is a perspective explanatory view of the printer body with an inkjet head lifted up;

FIG. 10A is a cross-sectional view of the printer body in a position of an inner wall face on a side of the left face;

FIG. 10B is an enlarged cross-sectional view of an area α illustrated with a broken line in FIG. 10A;

FIG. 11A is a perspective explanatory view in which the printer body with the upper unit open and the inkjet head removed is viewed from obliquely above on a side of the front face;

FIG. 11B is an enlarged perspective view of an area β illustrated with a broken line in FIG. 11A;

FIG. 12A is a perspective explanatory view in which the inkjet head is viewed from above on a side of the left rear face;

FIG. 12B is a perspective explanatory view in which the inkjet head is viewed from below on a side of the right rear face;

FIG. 13 is a cross-sectional view in which the printer body is viewed from a side of the left face;

FIG. 14A is a bottom view in a comparative example in which a thermistor is appropriately in surface contact with a sensor facing part of an inkjet head;

FIG. 14B is a side view in the comparative example;

FIG. 15A is a bottom view in a comparative example in which a thermistor is in contact, at an inclined angle, with a sensor facing part of an inkjet head;

FIG. 15B is a side view in the comparative example;

FIG. 16A is a bottom view in an example in which a thermistor is in contact with a ridgeline of an inkjet head;

FIG. 16B is a side view in the example;

FIG. 17A is a view from a normal direction of a detection face of a thermistor;

FIG. 17B is a view from a direction parallel to the detection face of the thermistor;

FIG. 18A is a perspective view illustrating an inkjet head and a head temperature sensor;

FIG. 18B is a front view of the inkjet head and the head temperature sensor that are illustrated in FIG. 18A;

FIG. 19 is an explanatory diagram illustrating an example of a pressing member that presses a thermistor against a ridgeline of an inkjet head in variation 1;

FIG. 20 is an explanatory diagram illustrating another example of the pressing member that presses the thermistor against the ridgeline of the inkjet head in variation 1;

FIG. 21A is an explanatory diagram illustrating a state in which a ridgeline of an inkjet head is separated from a detection face of a thermistor;

FIG. 21B is an explanatory diagram of an example in which a heat conductive sheet has been provided on a detection face of a thermistor in variation 2;

FIG. 22 is an explanatory diagram illustrating an example of a supporting configuration of the heat conductive sheet in variation 2;

FIG. 23 is an explanatory diagram illustrating another example of the supporting configuration of the heat conductive sheet in variation 2;

FIG. 24 is an explanatory diagram illustrating a supporting configuration of a head temperature sensor in variation 3;

FIG. 25 is a perspective view in which an inkjet head mounted in a holder has been cut so that a head temperature sensor is illustrated;

FIG. 26 is a cross-sectional view of the inkjet head mounted in the holder;

FIG. 27A is a side view illustrating a configuration of a head temperature sensor in variation 4; and

FIG. 27B is a front view of the configuration illustrated in FIG. 27A.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

Referring now to the drawings, wherein like reference numerals designate identical or corresponding parts throughout the several views thereof, an image forming apparatus according to an embodiment of this disclosure is described. As used herein, the singular forms “a”, “an”, and “the” are intended to include the plural forms as well, unless the context clearly indicates otherwise.

Descriptions are given below of a handheld mobile inkjet printer (hereinafter simply referred to as “handheld printer”) that is a mobile image forming apparatus, according to an embodiment of the present disclosure.

First, a basic configuration of a printer body of the handheld printer according to the present embodiment is described.

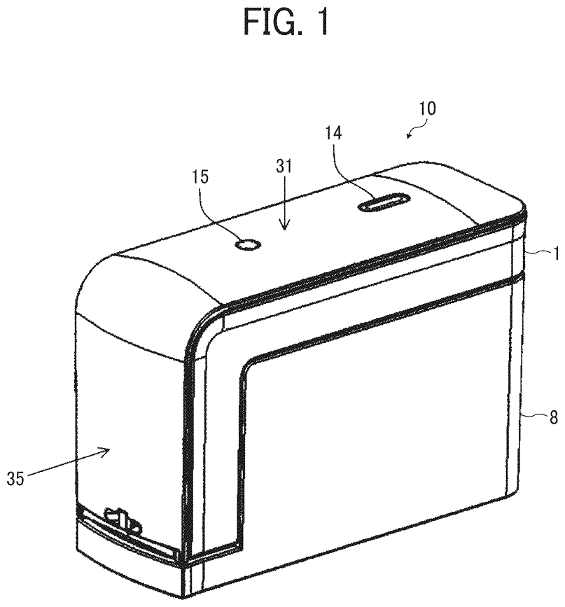

FIG. 1 is a perspective view illustrating an exterior of a handheld printer 10 according to the present embodiment, as viewed from obliquely above.

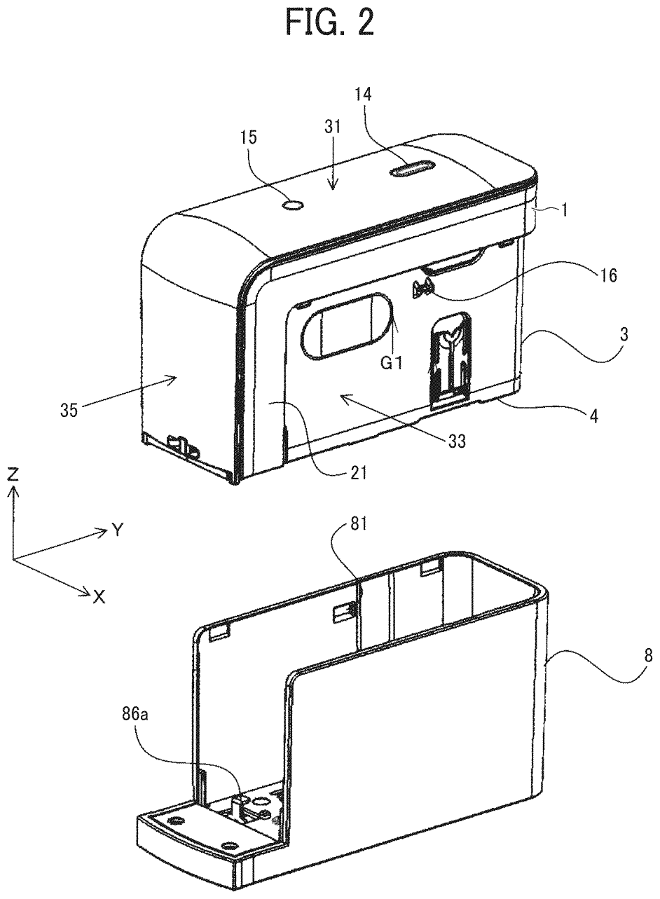

FIG. 2 is an exterior perspective view of the printer body 1 in which a cover 8 is removed from the printer body 1. The printer body 1 is an apparatus body of the handheld printer 10.

The handheld printer 10, according to the present embodiment, includes the printer body 1, a spacer 4 removably attached to the printer body 1, and the cover 8, which is attached to the printer body 1 with the spacer 4 housed in the cover 8. The cover 8 is made of resin such as acrylonitrile butadiene styrene (ABS) resin, and recesses 81 are formed on the inner wall surface thereof. When the cover 8 is attached to the printer body 1, two projections 16 (one of the two is illustrated in FIG. 2) provided on the printer body 1 are respectively hooked to two recesses 81 (one of the two is illustrated in FIG. 2) provided on the cover 8 by snap-fit. Thereby, the state in which the cover 8 is attached to the printer body 1 is held. When removing the cover 8 from the printer body 1, the user pulls the printer body 1 out of the cover 8 so that the projections 16 caught by the snap-fit are removed from the recesses 81 and the user can remove the cover 8 from the printer body 1.

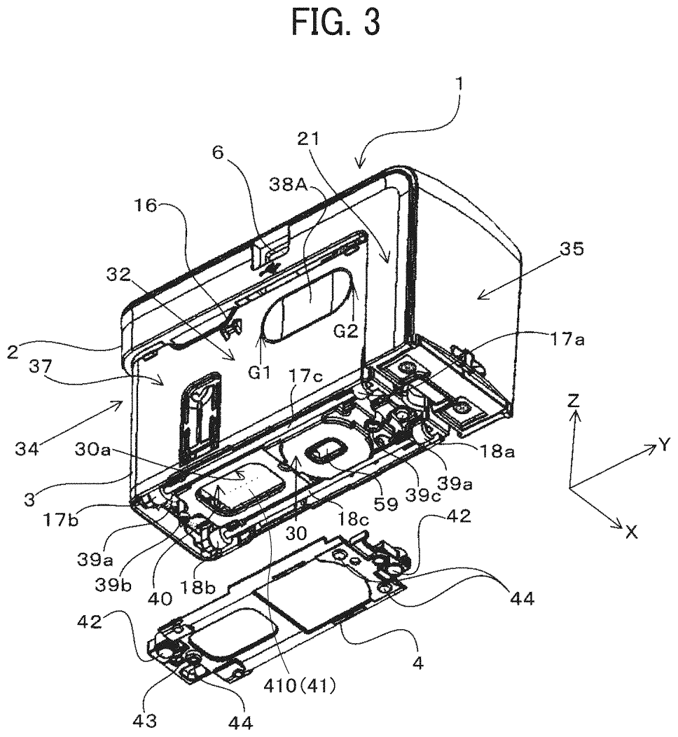

FIG. 3 is an exterior perspective view of the printer body 1 and the spacer 4 detached from the printer body 1, viewed obliquely from below.

The printer body 1 illustrated in FIG. 3 includes an upper unit 2 and a lower unit 3. The printer body 1 as a whole is shaped like a rectangular parallelepiped. In a scanning direction, that is, a printing direction indicated by arrow X in FIG. 1 (X-axis direction), the printer body 1 has such a length that a user can grasp the printer body 1 with a palm.

The housing of the handheld printer 10 includes a recording face 30, an upper face 31 opposite the recording face 30, a left face 32 extending in a direction indicated by arrow Y, orthogonal to the scanning direction (indicated by arrow X in the drawings) on the recording face 30. On the recording face 30, a nozzle section (a recording device or an image forming device) of an inkjet head described later faces a recording medium. The housing further includes, for example, a right face 33 extending in the direction orthogonal to the scanning direction (indicated by arrow X), a rear face 34 extending in the scanning direction, and a front face 35 extending in the scanning direction. The printer body 1 is usually used in such a posture that the recording face 30 is faced vertically down and the upper face 31, which is opposite the recording face 30, is faced vertical up.

A print button 14 as an image formation operation device and a power button 15 as a power operation device are disposed on the upper face 31. The left face 32 of the upper unit 2 includes a universal serial bus (USB) connection port 6. The USB connection port 6 is a port for connecting a USB cable. The printer body 1 is provided with a rechargeable battery mounted therein. The rechargeable battery can be charged when electric power is supplied thereto from an external power supply via the USB cable connected to the USB connection port 6.

On the front face 35 side of the lower unit 3, a wide portion 21 of the upper unit 2 wider than a narrow portion 37 of the lower unit 3 is positioned. The left and right faces 32 and 33 of the narrow portion 37 of the lower unit 3 include finger-grip portions 38A and 38B as finger rest portions to which the user applies his or her fingers. The finger-grip portions 38A and 38B are formed at the positions where the user applies the fingers (usually the thumb and one of the middle finger, the ring finger, and the little finger) of the hand, respectively, when the user holds and uses the printer body 1. To move the printer body 1 on a surface of the recording medium in the scanning direction (X-axis direction) for image formation, the user holds the printer body 1 as follows. The user positions the wide portion 21 closer to the wrist side and sandwiches the lower unit 3 with the fingers applied to the finger-grip portions 38A and 38B on the left and right faces 32 and 33, respectively.

In the present embodiment, the finger-grip portions 38A and 38b are shallow recesses or grooves having such a depth that a flat portion of a finger is caught therein, so that the finger is slightly caught thereby when the user grips the finger-grip portions 38A and 38B. The form of the finger rest portion is not limited to the recess or the groove as described above, and may be, for example, a projection or a protrusion. Moreover, as long as the user can recognize the positions where to apply fingers, the distinguishing of the finger rest portions is not limited to the shape. For example, the finger rest portion can be recognized with, instead of or in addition to the shape, an illustration such as a frame line colored differently from the remaining area of the side faces (the left and right faces 32 and 33).

The wide portion 21 is made wider than the narrow portion 37 in the scanning orthogonal direction so that the outer wall surface of the wide portion 21 and the outer wall surface of the cover 8 are on a substantially identical plane when the cover 8 is attached to the printer body 1, as illustrated in FIG. 1.

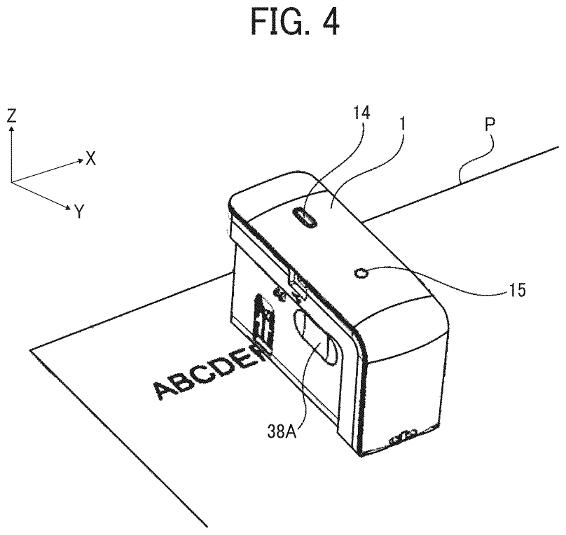

The user can switch on and off the power of the printer body 1 by holding down the power button 15. As described above, a structure that power is turned off by pressing the power button 15 for a while can suppress the erroneous operation of the power button 15 during the image forming operation. When the power is turned on, the control board provided in the upper unit 2 of the printer body 1 can acquire image data by wireless communication with a smartphone or the like. After the user places the printer body 1 on the surface of a recording medium P with the recording face 30 facing the surface of the recording medium P, the user presses the print button 14 once and moves the printer body 1 in the scanning direction (in X-axis direction) as illustrated in FIG. 4, thus forming an image on the recording medium P. The printer body 1 can form an image on the surface of the recording medium in both of forward movement and backward movement in the scanning direction (manual scanning) when the user moves the printer body 1 back and forth.

The recording medium P is not limited to paper, such as paper sheets, but includes any other image formation targets, for example, overhead projector (OHP) sheets, cloth, cardboards, packaging containers, glass, and substrates.

The upper unit 2 is held by the lower unit 3 to open and close with respect to the lower unit 3. The inkjet head 40 (a liquid discharge head) integral with an ink tank is mounted inside the lower unit 3. At this time, a nozzle section from which ink droplets are discharged is faced down in the vertical direction. The inkjet head 40 discharges ink droplets from the nozzle section to record an image on a recording medium.

As illustrated in FIG. 3, the recording face 30 of the printer body 1 includes an opening 30a to expose a nozzle section 410 (see FIG. 410) of the inkjet head 40 mounted in the lower unit 3 to the outside. The nozzle section 410 of the inkjet head 40 includes a plurality of discharge nozzles 41 and is capable of discharging ink droplets separately from the respective discharge nozzles 41 as piezoelectric elements are driven.

As a driving source to discharge ink, the inkjet head 40 employs, for example, an electromechanical transducer element (piezoelectric actuators) including a lamination-type piezoelectric element or a thin-film-type piezoelectric element; an electrothermal transducer element, such as a heat element; or an electrostatic actuator including a diaphragm and opposed electrodes.

The “ink (liquid)” discharged from the discharge nozzles 41 is not particularly limited as long as the liquid has a viscosity and a surface tension that enable discharge from the discharge nozzles 41. However, it is preferable that the viscosity is 30 mPa·s or less under ordinary temperature and pressure or by heating or cooling. Specifically, the term “liquid” represents, for example, a solution, a suspension, or an emulsion including a solvent, such as water or organic solvent, a colorant, such as a dye or a pigment, a polymerizable compound, a resin, a functional material, such as a surfactant, a biocompatible material, such as deoxyribonucleic acid (DNA), amino acid, protein, or calcium, or an edible material, such as a natural colorant. Such a solution, a suspension, or an emulsion can be used for, e.g., inkjet ink, surface treatment liquid, a liquid for forming components of electronic element or light-emitting element or a resist pattern of electronic circuit, or a material solution for three-dimensional fabrication.

Inside the outer edge of the recording face 30, a position detection sensor 59 as a detector to detect the position of the printer body 1 on the recording medium, a first left roller 17a, a second left roller 17b, a first right roller 18a, and a second right roller 18b that are rotatable are disposed.

When the user moves the printer body 1 in the scanning direction, the four rollers contacting the surface of the recording medium P rotate like tires. Owing to such rollers, the user can move forward or backward the printer body 1 straight in the scanning direction. At this time, only the four rollers of the printer body 1 are in contact with the surface of the recording medium and keep a predetermined distance between the recording face 30 and the surface of the recording medium. Therefore, a constant distance can be maintained between the nozzle section 410 of the inkjet head 40 and the surface of the recording medium, thus forming a desired high-quality image.

The position detection sensor 59 is a sensor to detect the distance to the surface of the recording medium, the surface state (for example, asperities) of the recording medium, and the distance by which the printer body 1 has traveled. The position detection sensor 59 is similar to a sensor used for, for example, an optical mouse (a pointing device) of a personal computer. The position detection sensor 59 irradiates, with light, a place (the recording medium) where the printer body 1 is placed and reads the state of the place as a “pattern”. The position detection sensor 59 sequentially detects how the “pattern” moves relative to the movement of the position detection sensor 59, to calculate the amount of movement.

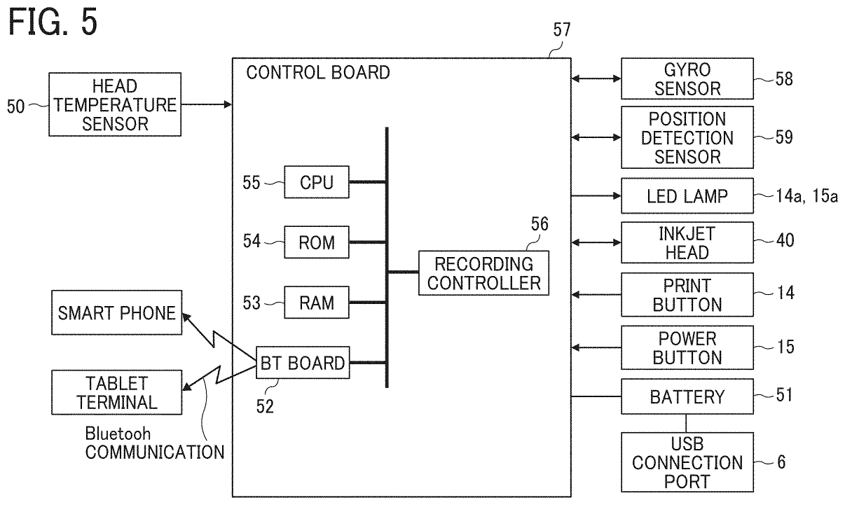

FIG. 5 is a block diagram illustrating a portion of an electric circuit of the printer body 1.

A control board 57 includes a central processing unit (CPU) 55 that performs various arithmetic processing and program execution, a Bluetooth (registered trademark, hereinafter “BT”) board 52 for short-range wireless communication, a random access memory (RAM) 53 that temporarily stores data, a read-only memory (ROM) 54, and a recording controller 56. The control board 57 is secured at a position on the back side of the USB connection port 6 in a hollow space of the upper unit 2.

The BT board 52 performs data communication by short-range wireless communication (Bluetooth communication) with an external device, such as a smartphone or a tablet terminal. The ROM 54 stores, for example, firmware for hardware control of the printer body 1 and drive waveform data of the inkjet head 40. The recording controller 56 executes data processing for driving the inkjet head 40 and generates drive waveforms.

The control board 57 is electrically connected to a gyro sensor 58, the position detection sensor 59, LED lamps 14a and 15a, the inkjet head 40, the print button 14, the power button 15, the battery 51, a head temperature sensor 50, and the like.

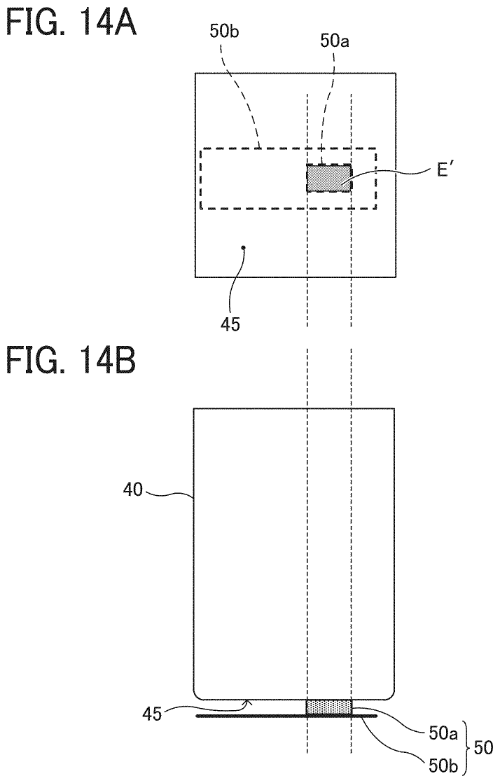

A head temperature sensor 50 is a temperature detection device that brings a thermistor 50a (a temperature detector, illustrated in FIGS. 14A and 14B) into contact with an inkjet head 40 to detect the temperature of the inkjet head 40. The inkjet head 40 is attachable to or detachable from a printer body 1. In the present embodiment, in order to keep the viscosity of discharged ink constant, feedback control is performed on a head heater in the inkjet head 40 based on a detection result of the head temperature sensor 50, and the temperature of ink in the inkjet head 40 is controlled to a target temperature. Details of the head temperature sensor 50 are described later.

The gyro sensor 58 detects the tilt and the rotation angle of the printer body 1 and transmits the detection result to the control hoard 57. The LED lamp 14a is disposed inside an exterior cover, made of a light transmissive material, of the print button 14 and makes the print button 14 luminous. Similarly, the LED lamp 15a is disposed inside an exterior cover made of a light transmissive material of the power button 15 and makes the power button 15 luminous.

When the power button 15 is pressed to turn on the power of the printer body 1, power is supplied to each module. The CPU 55 initiates startup according to the program stored in the ROM 54 and loads the program and each data in the RAM 53. When data of an image to be formed is received from an external device by short-range wireless communication, the recording controller 56 generates a drive waveform corresponding to the image data. Then, the discharge of ink from the inkjet head 40 is controlled to form an image corresponding to the position on the surface of the recording medium detected by the position detection sensor 59.

In response to acquisition of image data via short-range wireless communication from an external device, the control board 57 causes the LED lamp 14a to blink so that the light transmissive print button 14, which transmits light, becomes luminous and blinks. Seeing such blinking, the user knows that the image data is being acquired by the printer body 1. The control board 57 causes the LED lamp 14a to keep emitting light when acquisition of image data is completed and the image forming operation is feasible. Seeing such light emission, the user knows that the image forming operation is feasible, and the user places the printer body 1 on the recording medium and presses the print button 14.

Meanwhile, as the control board 57 starts blinking of the LED lamp 14a, the control board 57 waits for pressing of the print button 14. When the print button 14 is pressed, the control board 57 causes the LED lamp 14a to blink so that the print button 14 becomes luminous and blinks. Seeing such blinking, the user knows that printer body 1 is in image forming operation and starts moving (manual scanning) the printer body 1 in the scanning direction.

Finishing moving (manual scanning) of the printer body 1, the user presses the print button 14 again. With such an operation, the control board 57 turns off the LED lamp 14a and stops lighting of the print button 14. Or, there may be a case where the user does not press the print button 14 but picks up the printer body 1 from the recording medium and places the printer body 1 on, for example, a table or mounts the printer body 1 in the cover 8. In this case, at the timing when the user picks up the printer body 1 from the recording medium, the position detection sensor 59 no longer detects the position. At the timing when the position detection sensor 59 stops detecting the position, the control board 57 turns off the LED lamp 14a and stops lighting of the print button 14.

It is not necessary to keep pushing the print button 14 while the user moves (manual scanning) the printer body 1. Once the print button 14 is pushed and released before the moving of the printer body 1, the image forming operation based on the detection result by the position detection sensor 59 is continued until the end of the image formation, the print button 14 is pushed again, or the position detection sensor 59 becomes incapable of position detection.

The printer body 1 includes a left roller unit 17 and a right roller unit 18. The left roller unit 17 is attached to an end of the printer body 1 on the left face 32 side in the scanning direction (indicated by arrow X). The right roller unit 18 is attached to an end of the printer body 1 on the right face 33 side in the scanning direction.

The left roller unit 17 includes a metal shaft 17c, the first left roller 17a secured to one end side in the longitudinal direction of the shaft 17c, and the second left roller 17b secured to the other end side of the shaft 17c. Each of the first left roller 17a and the second left roller 17b is made of a material, such as rubber, having a relatively large frictional resistance.

The right roller unit 18 includes a metal shaft 18c, the first right roller 18a secured to one end side in the longitudinal direction of the shaft 18c, and the second right roller 18b secured to the other end side of the shaft 18c. Each of the first right roller 18a and the second right roller 18b is made of a material, such as rubber, having a relatively large frictional resistance.

As the both of two end portions of the shaft 17c in the longitudinal direction are fitted in sliding bearings fixed to the printer body 1, the left roller unit 17 is rotatably held by the sliding bearings. Similar to the left roller unit 17, the right roller unit 18 is rotatably held by sliding bearings 72 fixed to the printer body 1.

The left roller unit 17 and the right roller unit 18 are for enhancing the straight traveling performance of the printer body 1 in the scanning direction (indicated by arrow X). While the first left roller 17a and the second left roller 17b secured to the shaft 17c rotate together as one unit, the first right roller 18a and the second right roller 18b secured to the shaft 18c rotate together as one unit, thus improving the straight traveling performance.

In the printer body 1 according to the present embodiment, the rollers 17a and 17b of the left roller unit 17 and the rollers 18a and 18b of the right roller unit 18 are disposed at positions deviating from the nozzle section 410 in the orthogonal direction (indicated by arrow Y) to the scanning direction. In such an arrangement, when the printer body 1 is moved, the rollers 17a, 17b, 18a, and 18b are inhibited from contacting an image portion immediately after formed. Therefore, the image can be protected from being disturbed by the rollers 17a, 17b, 18a, and 18b contacting the image portion.

As described above, the shafts 17c and 18c as rotation shafts of the roller units 17 and 18 are made of metal. Compared with a structure using a nonmetallic shaft, use of the metal shaft is advantageous in suppressing bend of the shaft during moving of the printer body 1, thereby inhibiting the image from being disturbed by unstable traveling of the printer body 1 due to the flexure of the shaft. Further, the printer body 1 can be compact when a shaft having a small diameter is used.

Here, in the configuration provided with the rollers 17a, 17b, 18a, and 18b like the printer body 1 according to the present embodiment, as described above, when the user moves the printer body 1 in the scanning direction (manual scanning), the straight traveling performance is secured. However, the rollers 17a, 17b, 18a, and 18b inhibit smooth traveling when the printer body 1 is moved along a curved track, thus inhibit smooth manual scanning.

In addition, when recording on the second line is performed after recording on the first line, a line feed operation is required to move the printer body 1 in the scanning orthogonal direction with the recording face 30 kept facing the surface of the recording medium so that position detection by the position detection sensor 59 is not disabled. Also in the line feed operation, the rollers 17a, 17b, 18a, and 18b of the printer body 1 may inhibit the movement in the scanning orthogonal direction and become a hindrance to a smooth line feed operation.

Therefore, the handheld printer 10 of the present embodiment is provided with the spacer 4 which is attachable to and detachable from the recording face 30 of the printer body 1, and the usage form of the handheld printer 10 can be switched by attaching and detaching the spacer 4. Specifically, the usage form can be switched between a roller contact state in which scanning is performed while the rollers 17a, 17b, 18a and 18b are in contact with the surface of the table on which the recording medium P is placed or the surface of the recording medium P and a roller contactless state in which the rollers 17a, 17b, 18a and 18b are not in contact with the surface of the table on which the recording medium P is placed or the surface of the recording medium P.

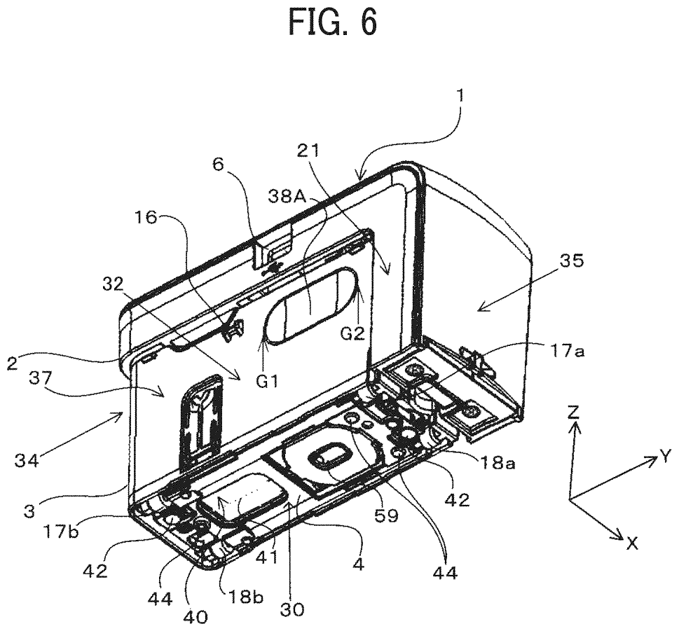

FIG. 6 is an exterior perspective view of the printer body 1 in a state in which the spacer 4 is attached, as viewed obliquely from below.

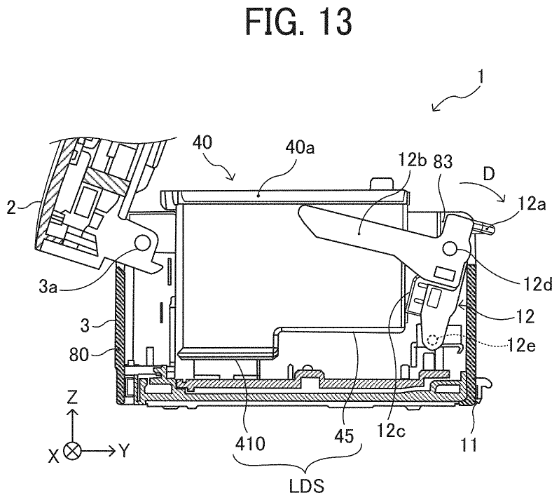

When the spacer 4 is detached from the printer body 1, the handheld printer 10 can be used in the roller contact state in which the printer body 1 is moved for scanning with the rollers 17a, 17b, 18a, and 18b of the printer body 1 in contact with and rolling on the surface of the recording medium P as illustrated in FIG. 13. As a result, owing to straight traveling performance of the rollers 17a, 17b, 18a, and 18b, the user can easily move the printer body 1 straight along the scanning direction and can form an appropriate image. On the other hand, when the spacer 4 is attached to the recording face 30 of the printer body 1, the handheld printer 10 can be used in the roller contactless state in which the printer body 1 is moved for scanning with the rollers 17a, 17b, 18a, and 18b of the printer body 1 contactless with the surface of the recording medium P and the like as illustrated in FIG. 6.

The spacer 4 is attached to and detached from the recording face 30 of the lower unit 3 with magnets. Specifically, the spacer 4 includes magnets 42, and screw heads 39a of two metal screws (fastening members) that are magnetic are exposed to the recording face 30. The magnets 42 are disposed to oppose the screw heads 39a when the spacer 4 is attached to the recording face 30 of the printer body 1. In the present embodiment, the magnetic body provided on the spacer 4 is described as an example of a fastening member such as a metal screw, but may be a frame member such as a metal frame of the spacer 4. Such a frame member is usually made of metal in order to secure rigidity and can be used as a magnetic body.

Further, as illustrated in FIG. 3, in order to align the recording face 30 of the lower unit 3 with the spacer 4, an alignment projection 39b and an alignment hole 39c are formed on the recording face 30. On the spacer 4, an alignment hole 43 where the alignment projection 39b fits and an alignment projection which fits in the alignment hole 39c are formed at respective corresponding positions. When the spacer 4 is properly aligned with the recording face 30 such that the alignment projection and the alignment hole fit in and around the alignment hole and alignment projection on the other side, the magnets 42 on the spacer 4 face the screw heads 39a of the recording face 30. Then, as illustrated in FIG. 6, the spacer 4 is mounted and held onto the recording face 30 by magnetic force of the magnets 42.

The body of the spacer 4 is made of resin such as ABS resin. Three projections 44 to support the printer body 1 are provided on a recording medium opposing side) of the spacer 4, which is opposite the side facing the recording face 30 when the spacer 4 is attached to the printer body 1. The tips of the projections 44 of the spacer 4 mounted on the recording face 30 of the printer body 1 are farther from the recording face 30 than the rollers 17a, 17b, 18a, and 18b in the direction in which the recording side faces the recording medium P. Therefore, when the printer body 1 to which the spacer 4 is attached is placed on the recording medium P, the tips of the projections 44 contact the recording face 30 to float the rollers 17a, 17b, 18a, and 18b from the surface of the recording medium P. Then, the handheld printer 10 is in the roller contactless state.

To use the handheld printer 10 in the roller contactless state, the user holds the printer body 1 and places the printer body 1 on the recording medium P so that the recording face 30 to which the spacer 4 is attached opposes the surface of the recording medium P. At that time, the printer body 1 is supported at three points by the projections 44 of the spacer 4 so that the rollers 17a, 17b, 18a, and 18b float from the surface of the recording medium P. Then, the user can move the printer body 1 (manual scanning) so that the three projections 44 slide on the surface of the recording medium P, to form an image on the recording medium P.

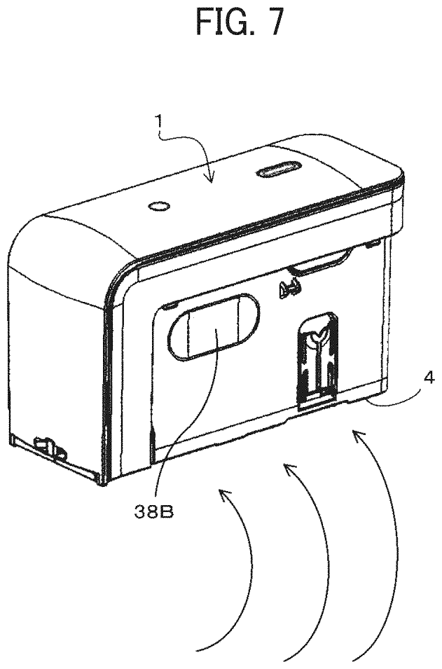

FIG. 7 is a perspective view illustrating the printer body 1 being moved along a curved track in the roller contactless state.

In the roller contactless state, since the rollers 17a, 17b, 18a, and 18b float from the surface of the recording medium P, an operation of moving the printer body 1 (manual scanning) in a direction different from the scanning direction (X-axis direction) is not disturbed by the rollers 17a, 17b, 18a, and 18b. Therefore, the curved traveling performance of the printer body 1 is improved compared to the roller contact state. As a result, the printer body 1 can be easily moved along the curved track.

In addition, in a case where, after recording of the first line in the scanning direction, recording of the second line is performed at a position different in the scanning orthogonal direction, the rollers 17a, 17b, 18a, and 18b do not disturb the line feed operation to move the printer body 1 in the scanning orthogonal direction with the recording face 30 kept facing the recording medium. Therefore, the operability of the line feed operation is improved compared to the roller contact state. In the roller contactless state, since the straight traveling performance by the rollers 17a, 17b, 18a, and 18b is not feasible, the user needs to move the printer body 1 straight in the scanning direction without assistance from the rollers 17a, 17b, 18a, and 18b.

Each of the three projections 44 of the spacer 4 is disposed out of the range of the nozzle section 410 (where the plurality of discharge nozzles 41 are located) of the inkjet head 40 in the direction (Y-axis direction) orthogonal to the scanning direction. Thus, the image can be protected from being disturbed by the projections 44 rubbing against the image portion immediately after formed during image formation in the roller contactless state.

Next, an operation to detach the inkjet head 40 of the handheld printer 10 according to the present embodiment is described.

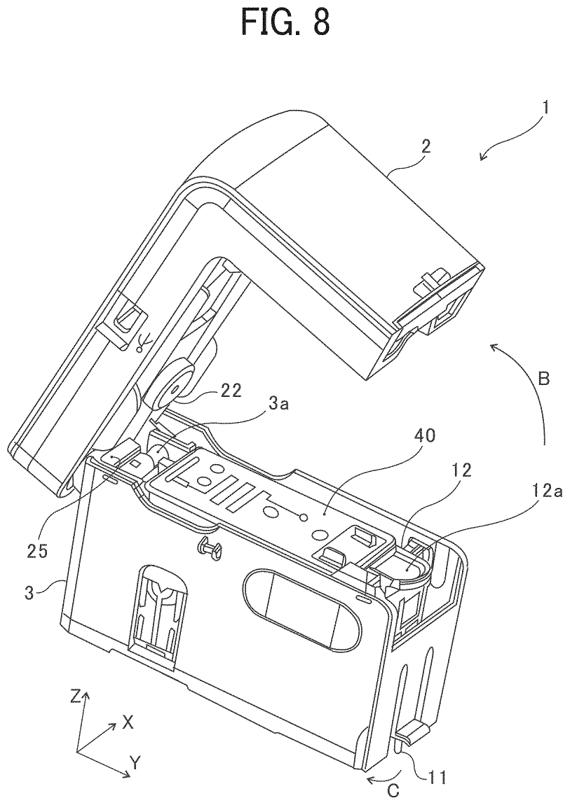

FIG. 8 is a perspective view of the printer body 1 and illustrates a state in which an upper unit 2 has been rotated with respect to the lower unit 3 in a direction of arrow B in this drawing to enter into an open state.

The lower unit 3 of the printer body 1 includes a lock claw 11 in a lower part of an end face on a side of the front face. The lock claw 11 is operated to move in a direction of arrow C in FIG. 8, so that the securing of the upper unit 2 to the lower unit 3 is released. In a state in which securing has been released, the upper unit 2 is rotated with respect to the lower unit 3 in the direction of arrow B in FIG. 8 with an upper unit rotary shaft 3a as a center, so that the upper unit 2 enters into an open state, as illustrated in FIG. 8.

The upper unit 2 enters into an open state. Therefore, the inkjet head 40 and a cartridge attaching and detaching mechanism 12 inside the printer body 1 are exposed. The upper unit 2 includes a head pressing member 22 on the inner face. The head pressing member 22 presses and locks the inkjet head 40 mounted in the lower unit 3.

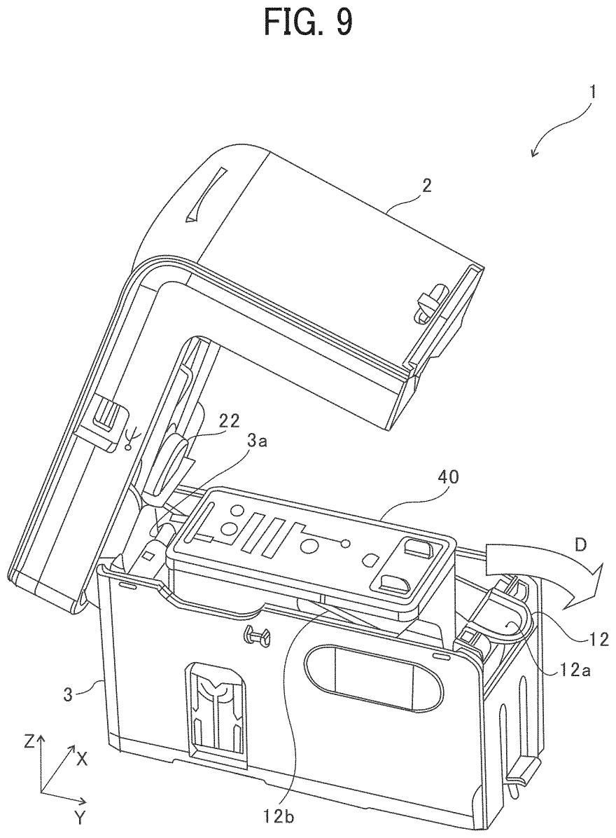

FIG. 9 is a perspective view of the printer body 1 in a state in which an operation portion 12a (e.g., a lever or a handle) of the cartridge attaching and detaching mechanism 12 has been operated in the printer body 1 having the state illustrated in FIG. 8 and the inkjet head 40 has been lifted up.

The operation portion 12a of the cartridge attaching and detaching mechanism 12 is pulled to a side of the front face, as illustrated by arrow D in FIG. 9, so that the inkjet head 40 is lifted up from the state illustrated in FIG. 8 to enter into the state illustrated in FIG. 9. Thus, the inkjet head 40 enters into a detachable state.

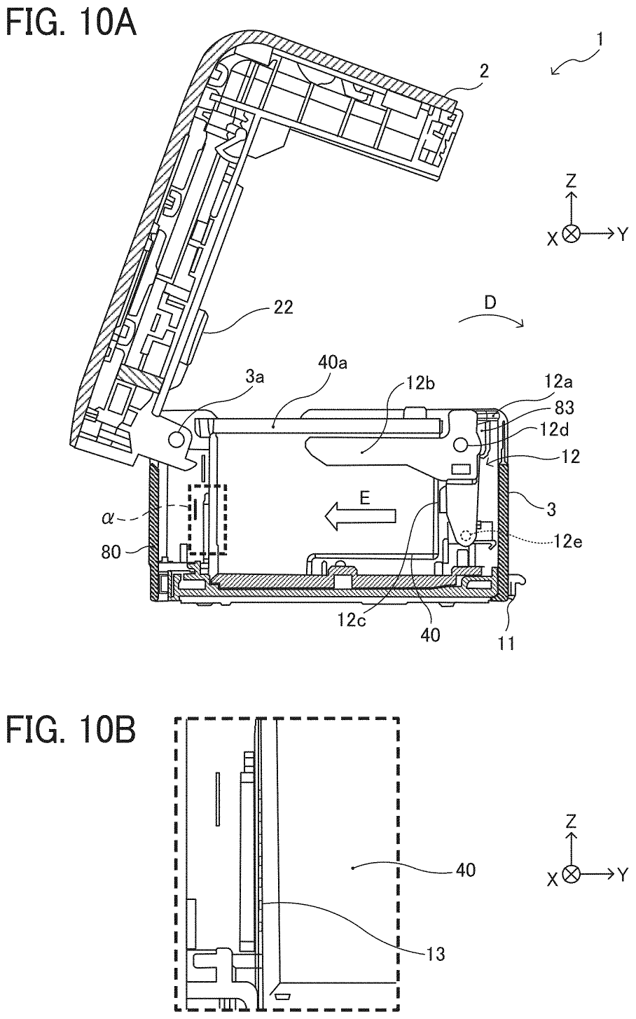

FIG. 10A is a cross-sectional view in which the printer body 1 illustrated in FIG. 8 is viewed from a side of a left face 32.

FIG. 10A is a cross-sectional view of the printer body 1 in a position of an inner wall face on the side of the left face 32. FIG. 10B is an enlarged cross-sectional view of an area α illustrated with a broken line in FIG. 10A.

As illustrated in FIG. 10A, a pressing portion 12c of the cartridge attaching and detaching mechanism 12 applies pressure onto a face on a side of the front face (the right side in FIG. 10A) of the inkjet head 40 to press the inkjet head 40 to a side of the rear face (a left side in FIG. 10A), as illustrated by arrow E in FIG. 10A. Thus, a contact of the inkjet head 40 is pressed against a flexible printed circuit (FPC) contact 13 in the printer body 1.

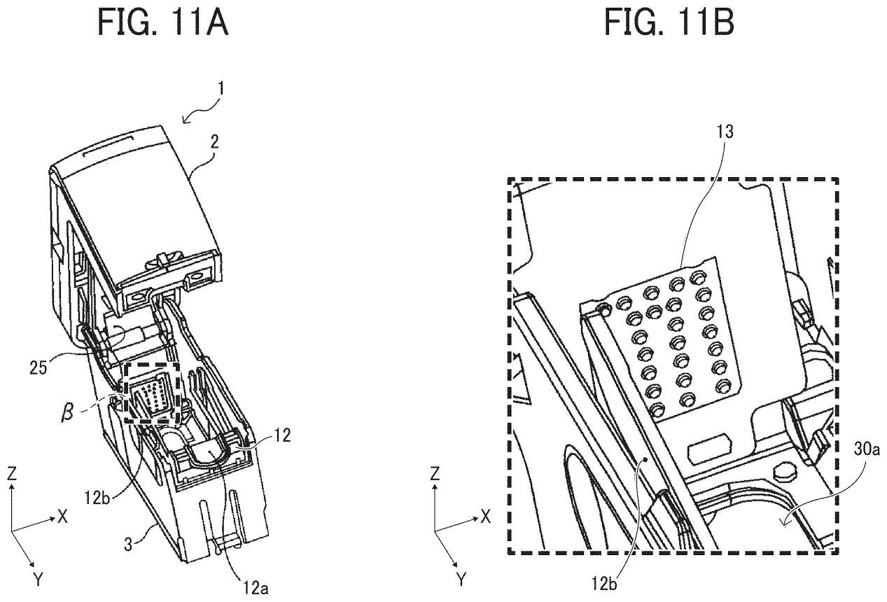

FIG. 11A is a perspective explanatory view in which the printer body 1 with the upper unit 2 open and the inkjet head 40 detached is viewed from obliquely above on a side of the front face.

FIG. 11B is an enlarged perspective view of an area β illustrated with a broken line in FIG. 11A.

As illustrated in FIG. 11A, the lower unit 3 includes the FPC contact 13 on an inner wall face on a side of a rear face of a space in which the inkjet head 40 is arranged.

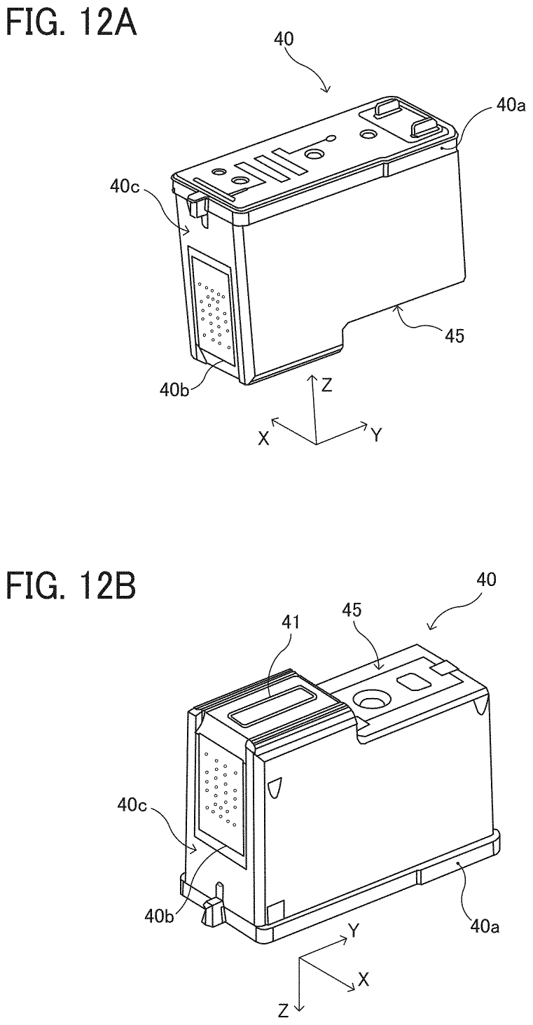

FIGS. 12A and 12B are perspective explanatory views only illustrating the inkjet head 40.

FIG. 12A is a perspective explanatory view in which the inkjet head 40 is viewed from above on a side of the left rear face. FIG. 12B is a perspective explanatory view in which the inkjet head 40 is viewed from below on a side of the fight rear face.

As illustrated in FIGS. 12A and 12B, the inkjet head 40 includes a cartridge contact 40b on an outer wall face on a side of the rear face.

The inkjet head 40 is mounted in the lower unit 3, and the FPC contact 13 and the cartridge contact 40b are electrically coupled to each other. Thus, power is supplied from the battery 51 to the inkjet head 40. In addition, an electric signal that controls the inkjet head 40 is transmitted to the inkjet head 40.

As illustrated in FIG. 8, the flexible flat cable 25 is disposed on a side of a rear face 34 of the upper unit rotary shaft 3a. The flexible flat cable 25 couples the control board 57 in the upper unit 2 and the FPC contact 13 in the lower unit 3. The flexible flat cable 25 is deformable according to an opening/closing operation of the upper unit 2. Even when the opening/closing operation of the upper unit 2 is repeated, a coupling state of the control board 57 and the FPC contact 13 can be maintained.

FIG. 13 is a cross-sectional view in which the printer body 1 is viewed from a side of the left face 32. FIG. 13 is a cross-sectional view of the printer body 1 in a position of an inner wall face of a wall on the side of the left face 32, similarly to FIG. 10A and 10B.

The operation portion 12a of the cartridge attaching and detaching mechanism 12 is pulled to a side of the front face 35, as illustrated by arrow D in FIG. 13, so that the cartridge attaching and detaching mechanism 12 rotates to the side of the front face 35 with a rotation shaft 12e as a center. At this time, the cartridge attaching and detaching mechanism 12 rotates until a stopper projecting portion 12d of the cartridge attaching and detaching mechanism 12 fits in a stopper groove on the inner wall face of the printer body 1. Due to this rotation, a push-up lever 12b of the cartridge attaching and detaching mechanism 12 pushes up a flange 40a of the inkjet head 40, and the inkjet head 40 is lifted up from the state illustrated in FIG. 8 to enter into the state illustrated in FIG. 9 (the state illustrated in FIG. 13). Thus, the inkjet head 40 enters into a detachable state.

In the printer body 1 according to the present embodiment, the lock claw 11 is operated to release the securing of the upper unit 2 to the lower unit 3, and the upper unit 2 enters into an open state. This causes the cartridge attaching and detaching mechanism 12 to be exposed. The cartridge attaching and detaching mechanism 12 is operated to lift up the inkjet head 40. The cartridge attaching and detaching mechanism 12 may lift up the inkjet head 40 in conjunction with an operation to open the upper unit 2.

In a case where the inkjet head 40 is mounted in the printer body 1, the inkjet head 40 is set in a cavity of the lower unit 3 in the printer body 1 with the upper unit 2 open. At this time, an operation is performed to press an upper face of the inkjet head 40 that has been set to the state illustrated in FIG. 9, and the inkjet head 40 is inserted to have the state illustrated in FIG. 8. Then, the upper unit 2 is closed. Thus, an image can be formed by using the mounted inkjet head 40.

In the printer body 1 according to the present embodiment, the upper unit 2 can be closed in the state illustrated in FIG. 9 without performing an operation to press the upper face of the inkjet head 40 that has been set to the state illustrated in FIG. 9. In this case, the head pressing member 22 of the upper unit 2 presses the upper face of the inkjet head 40 that is located in the same position as a position at the time of being lifted up, and the inkjet head 40 is inserted to have the state illustrated in FIG. 8.

In the printer body 1 according to the present embodiment, only the upper unit 2 is a member that is opened or closed when the inkjet head 40 is attached or detached. Therefore, a configuration can be simplified and the size of an apparatus can be reduced in comparison with a configuration including a plurality of opening/closing members as described above. Further, due to a reduction in the number of members to be opened or closed by a user, the number of operation processes can be reduced at the time of attaching or detaching the inkjet head 40. Thus, operability can be improved.

Note that, in FIG. 13, a liquid discharge side LDS (lower side in FIG. 13) of the inkjet head 40 includes the nozzle section 410 and a sensor facing section 45.

Next, the detection of the temperature of the inkjet head 40 according to the present embodiment is described.

In the present embodiment, the head temperature sensor 50 brings the thermistor 50a illustrated in FIG. 14A (a temperature detector) into contact with the inkjet head 40 to detect the temperature of the inkjet head 40. Normally, in a case where the thermistor 50a is to contact the inkjet head 40 to detect temperature, a detection face of the thermistor is brought into surface contact with a face of the inkjet head 40 in order to secure a large contact area, thereby reducing errors of the detection of temperature (a difference between an actual temperature and a detected temperature).

FIGS, 14A and 14B are exemplary diagrams illustrating comparative examples in which the thermistor 50a is brought into surface contact with the sensor facing section 45 (see FIGS. 12A and 13), which faces the position detection sensor 59 of the printer body 1) of the inkjet head 40. The sensor facing section 45 is separated from the nozzle section 410 (the recording device) including the discharge nozzles 41 (see FIG. 6) on the bottom face of the inkjet head 40 (on the side of the recording face 30 of the printer body 1). FIG. 14A is a bottom view for explaining a contact area E′ with the thermistor 50a illustrated in FIG. 14A omitted. FIG. 14B is a side view for explaining a contact state of the thermistor 50a illustrated in FIG. 14A.

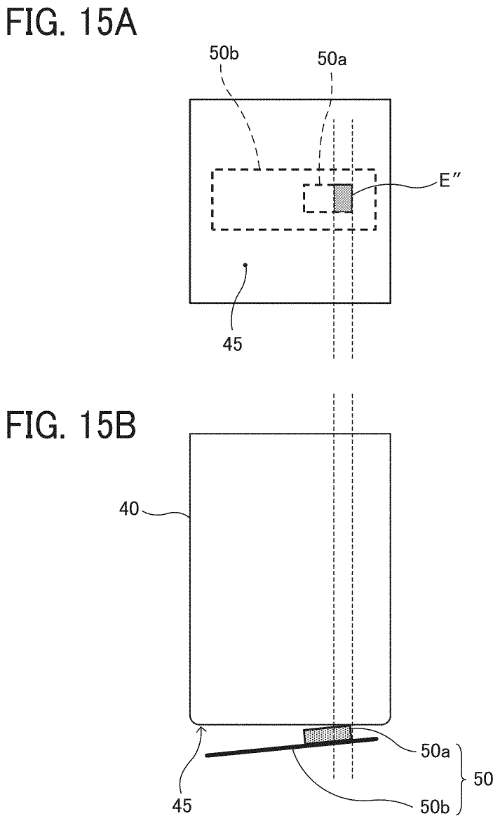

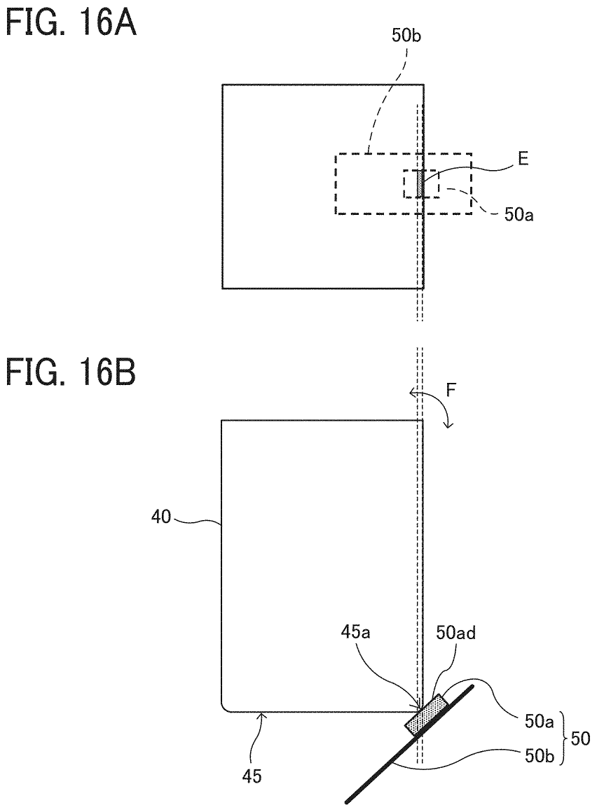

As illustrated in FIGS. 14A and 14B, in a case where the thermistor 50a is appropriately in surface contact with a face of the sensor facing section 45 of the inkjet head 40 without forming any gap, the contact area E′ can have the same area as an area of the detection face (e.g., a detection face 50ad in FIG. 16B) of the thermistor 50a. However, the inkjet head 40 that is attachable to or detachable from the printer body 1 normally has an error of a mounting position or a mounting posture, and the mounting position or the mounting posture varies in each mounting. Accordingly, in some cases, the face of the sensor facing section 45 of the inkjet head 40 is appropriately in surface contact with the detection face of the thermistor 50a, as illustrated in FIGS. 14A and 14B. In other cases, the face of the sensor facing section 45 is inappropriately in contact with the detection face of the thermistor 50a, for example, in an inclined state, as illustrated in FIGS. 15A and 15B. There is also a possibility of inappropriate contact such as contact in a state in which the detection face of the thermistor 50a partially separates from the face of the sensor facing section 45 of the inkjet head 40.

In a case where the mounting position or the mounting posture has a small variation but in a case where the position or posture of the thermistor 50a varies due to a manufacturing error or an assembling error or the position or posture of the thermistor 50a is displaced from a normal position or posture due to, for example, being caught by something after assembly, there is a possibility of the regular occurrence of inappropriate contact.

As described above, an inappropriate contact state, as illustrated in FIGS. 15A and 15B, results in a contact area E″ that is significantly different from the contact area E′ in the appropriate contact state illustrated in FIGS. 14A and 14B. This causes a significant difference between a detected temperature in the inappropriate contact state and a detected temperature in the appropriate contact state. As a result, in a configuration where the thermistor 50a is brought into surface contact with the inkjet head 40 and temperature is detected, a state of contact between the thermistor 50a and the inkjet head 40 varies in every mounting, and this results in a large variation in detected temperature. In a situation where an inappropriate state of contact between the thermistor 50a and the inkjet head 40 constantly occurs, detected temperature has a large error, and temperature fails to be appropriately detected.

In view of this, in the head temperature sensor 50 according to the present embodiment, the thermistor 50a is brought into line contact with the inkjet head 40, and temperature is detected. Specifically, as illustrated in FIGS. 16A and 16B, the detection face 50ad of the thermistor 50a is to contact a ridgeline on the inkjet head 40. More particularly, the detection face 50ad contacts a ridgeline on the liquid discharge side LDS (on which the discharge nozzles 41 are formed) of the inkjet head 40. Yet more particularly, the detection face 50ad contacts a ridgeline 45a of the sensor facing section 45 of the inkjet head 40 (away from the nozzle section 410).

A contact area E in such a line-contact configuration is smaller than the contact area E′ in the case of surface contact. Therefore, even when the mounting position or the mounting posture slightly deviates, changes in the contact area between an inappropriate contact state and an appropriate contact state can be smaller. Therefore, the differences can be reduced between a detected temperature in the inappropriate contact state and a detected temperature in the appropriate contact state, and a variation in detected temperature can be reduced.

In particular, according to the present embodiment, even in a case where the inkjet head 40 mounted is inclined (so as to rotate around the line of line contact) as illustrated by arrow F in FIG. 16B, the contact state can be similar to the contact state in the state where the inkjet head 40 is not inclined, that is the contact area is constant. Therefore, variations in the detected temperature can be reduced. Similarly, even in a case where the thermistor 50a has an installation error around the line of line contact, the contact state can be similar to the contact state without any installation error (the contact area is constant). Therefore, the detection of temperature has a small error, and temperature can be appropriately detected.

In addition, it is preferable that the detection face 50ad of the thermistor 50a have such a shape (a square shape, a rectangular shape, or the like) that the length in the linear contact direction is constant. With such a shape, the length of line contact does not change even when the mounting position (contact position) deviates in the direction orthogonal to the linear direction of line contact. This causes a contact state (a constant contact area) to be maintained even when the mounting position (the contact position) is displaced in the direction orthogonal to the linear direction of line contact. Therefore, a variation in detected temperature can be reduced. Similarly, the detection of temperature has a small error, and temperature can be appropriately detected.

In the configuration in which the thermistor 50a is in line contact with the inkjet head 40, as in the present embodiment, the contact area E is smaller than the contact area in the case of surface contact. Therefore, the accuracy of the detection of temperature is reduced compared with the case of surface contact. However, giving high priority to reducing variations in the detected temperature over detecting a more accurate temperature is advantageous in stably controlling the temperature of ink. Thus, the viscosity of ink can be stably maintained within an appropriate range.

The “line contact” described above represents not line contact in strict meaning but contact having a predetermined width and contact having a long and narrow shape.

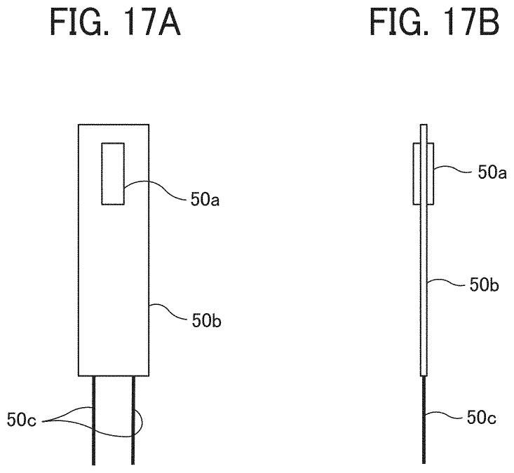

FIGS. 17A and 17B are diagrams illustrating a configuration of the head temperature sensor 50. FIG. 17A is a view from a normal direction of the detection face 50ad of the thermistor 50a. FIG. 17B is a view from a direction parallel to the detection face 50ad of the thermistor 50a.

In the head temperature sensor 50 according to the present embodiment, leads 50c extending from the thermistor 50a and the thermistor 50a are covered with a resin 50b such as silicone resin. A resistance value of the thermistor 50a changes due to heat transfer from the inkjet head 40 to the thermistor 50a. The resistance value is measured by a measuring device that is implemented by a central processing unit (CPU) or the like on the control board 57, so that the temperature of the inkjet head 40 is detected.

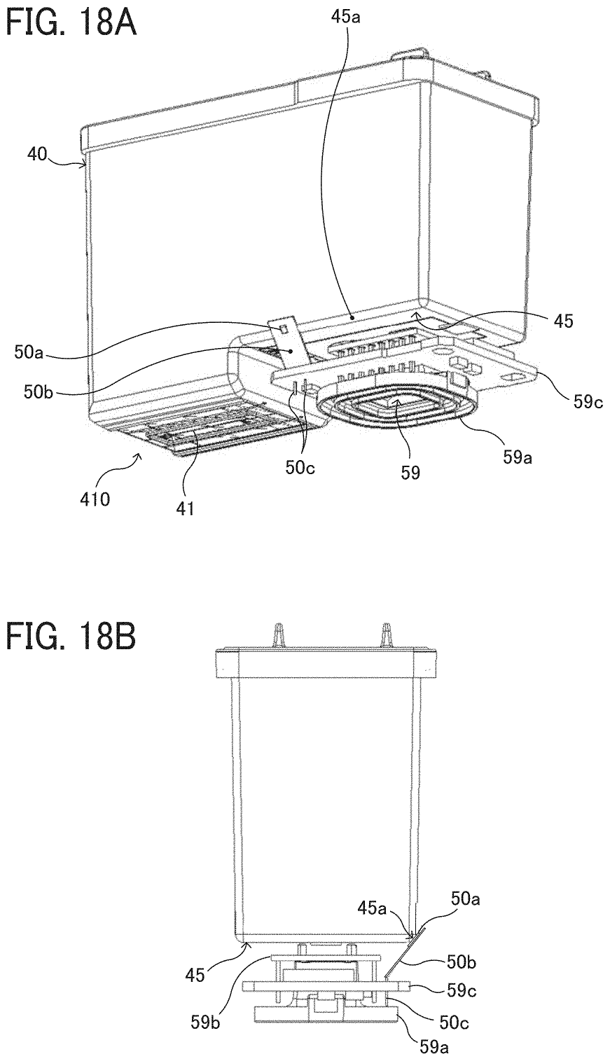

FIG. 18A is a perspective view illustrating the inkjet head 40 and the head temperature sensor 50. FIG. 18B is a front view.

In the present embodiment, the leads 50c of the thermistor 50a are soldered to a circuit board 59c of the position detection sensor 59, and the measuring device of the head temperature sensor 50 includes the control board 57. The position detection sensor 59 includes a sensor board 59b attached to an upper side of the circuit board 59c (on the side of the sensor facing section 45 of the inkjet head 40). An image sensor is mounted on the sensor board 59b. An image capturing lens 59a is mounted on a lower side of the circuit board 59c.

As described above, the head temperature sensor 50 according to the present embodiment is mounted on the circuit board 59c of the position detection sensor 59. Therefore, a circuit board for the head temperature sensor 50 does not need to be separately provided, and this has the advantage of space saving.

The thermistor 50a is pressed by the ridgeline 45a of the inkjet head 40 when the thermistor 50a comes into line contact with the ridgeline 45a. Pressing force is transferred via the leads 50c to a soldered part on the circuit board 59c, and there is a possibility that solder will be peeled off. Therefore, it is preferable that the soldered portions of the leads 50c of the thermistor 50a are covered with resin and be secured. By doing this, pressing force is received by resin, and is not transferred to the soldered part. Thus, solder can be prevented from being peeled off.

In addition, in the present embodiment, the temperature of ink inside the inkjet head 40 is detected in order to manage the viscosity of ink to be discharged from the inkjet head 40. Therefore, it is preferable that the temperature of ink be detected in a position as close as possible to the discharge nozzle 41. Therefore, as illustrated in FIG. 18A, the lead 50c of the thermistor 50a is attached in a position close to the discharge nozzle 41 in the circuit board 59c of the position detection sensor 59. Thus, the thermistor 50a comes into line contact with the inkjet head 40 in a position close to the discharge nozzle 41.

In the inkjet head 40 according to the present embodiment, the ridgeline 45a that the thermistor 50a comes into contact with is not a sharp corner, but has a round shape (R shape). A detection face that is planar or has a projecting shape of the thermistor 50a contacts (abuts on) the ridgeline 45a having a round shape (R shape), as described above. Thus, line contact is attained. Thus, line contact is implemented.

In the present embodiment, when the inkjet head 40 is mounted, and specifically, when an operation is performed to press the upper face of the inkjet head 40 that has been set to the state illustrated in FIG. 9 and the inkjet head 40 is inserted to have the state illustrated in FIG. 8, the ridgeline 45a of the inkjet head 40 is pressed against the thermistor 50a on a side of the printer body 1. At this time, restoring force is generated due to the elastic deformation of the lead 50c or the resin 50b, and the thermistor 50a is pressed against the ridgeline 45a of the inkjet head 40 to abut onto the ridgeline 45a.

As described above, according to the present embodiment, the thermistor 50a can be brought into line contact with the inkjet head 40. Thus, the contact area is smaller than the contact area in the case of surface contact, and changes in the contact area between an inappropriate contact state and an appropriate contact state can be reduced. Therefore, a difference is small between a detected temperature in the inappropriate contact state and a detected temperature in the appropriate contact state, and a variation in detected temperature can be reduced. Even in a situation where an inappropriate state of contact between the thermistor 50a and the inkjet head 40 constantly occurs, the detection of temperature has a small error, and temperature can be appropriately detected.

Variation 1

Next, a variation of the head temperature sensor 50 according to the present embodiment (hereinafter, this variation is referred to as “variation 1”) is described.

In a case where an elastically deformable range of the lead 50c or the resin 50b is small or where it is possible that the lead 50c or the resin 50b plastically deforms, the following disadvantage may occur. Due to repeated attaching or detaching of the inkjet head 40, the contact pressure at the time of mounting may be insufficient between the ridgeline 45a of the inkjet head 40 and the thermistor 50a. Or, there is a possibility that the thermistor 50a may fail to contact the ridgeline 45a. Similarly in the case of a poor position accuracy in a contact-separation direction of the thermistor 50a and the ridgeline 45a of the inkjet head 40, a sufficient contact pressure fails to be obtained between the ridgeline 45a of the inkjet head 40 at the time of mounting and the thermistor 50a, or there is a possibility that a non-abutting state will occur.

Variation 1 indicates an example in which a pressing member is provided that presses the thermistor 50a against the ridgeline 45a of the inkjet head 40.

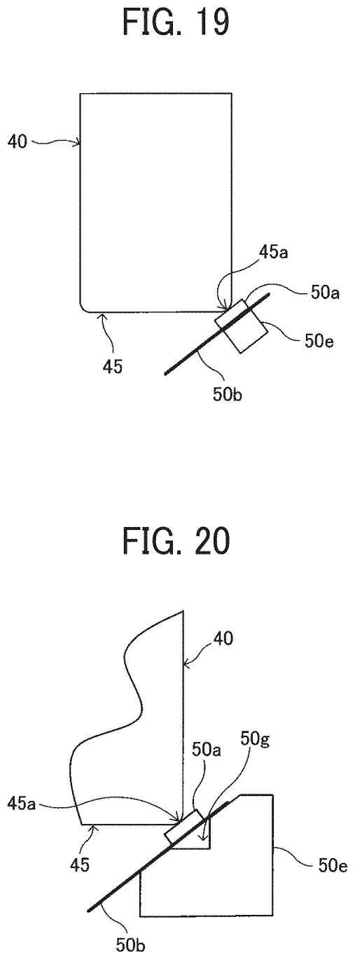

FIG. 19 is an explanatory diagram illustrating an example of the pressing member that presses the thermistor 50a against the ridgeline 45a of the inkjet head 40.

In variation 1, as the pressing member, a pressure sponge 50e is provided on the inner wall face of the printer body 1 to abut onto a rear face of the detection face 50ad of the thermistor 50a, as illustrated in FIG. 19. The pressure sponge 50e is an elastic member. Therefore, restoring force is generated due to the elastic deformation of the pressure sponge 50e, and the restoring force enables the thermistor 50a to be pressed against the ridgeline 45a of the inkjet head 40. As a result, even in a case where the lead 50c or the resin 50b has a small elastically deformable range or in a case where there is a possibility that the lead 50c or the resin 50b will be plastically deformed, or even in the case of a poor position accuracy in a contact-separation direction of the thermistor 50a and the ridgeline 45a of the inkjet head 40, contact pressure can be stably obtained, and an appropriate state of line contact between the thermistor 50a and the ridgeline 45a of the inkjet head 40 can be stably obtained.

FIG. 20 is an explanatory diagram illustrating another example of the pressing member that presses the thermistor 50a against the ridgeline 45a of the inkjet head 40.

As the pressing member in variation 1, in the pressure sponge 50e illustrated in FIG. 19, a portion that faces the rear face of the detection face 50ad of the thermistor 50a may have a recess 50g or may have a groove shape. By doing this, the displacement of the thermistor 50a in the contact-separation direction of the thermistor 50a and the ridgeline 45a of the inkjet head 40 has an increased degree of freedom in an extending direction (a linear direction of line contact) of the ridgeline 45a. As a result, even when the ridgeline 45a of the inkjet head 40 is not parallel to the detection face 50ad of the thermistor 50a, a position in the contact-separation direction of the detection face 50ad of the thermistor 50a can move by a variable amount in the extending direction (the linear direction of line contact) of the ridgeline 45a, and the ridgeline 45a of the inkjet head 40 can be appropriately brought into line contact with the detection face 50ad of the thermistor 50a.

Variation 2

Next, another variation of the head temperature sensor 50 according to the present embodiment (hereinafter, this variation is referred to as “variation 2”) is described.

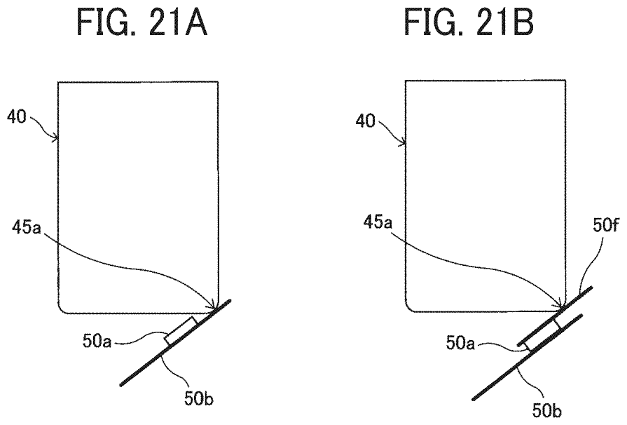

Referring to FIG. 21A, a description is given of a poor position accuracy of the thermistor 50a and the ridgeline 45a of the inkjet head 40 in an apparatus lateral direction (the lateral direction in FIG. 21A) orthogonal to both a mounting direction of the inkjet head 40 and a linear contact direction (perpendicular to the surface of the sheet on which FIG. 21A is drawn). Here, the “mounting direction of the inkjet head 40” is the lateral direction in FIG. 21A and the direction in which the inkjet head 40 is inserted to the position illustrated in FIG. 8 by pressing the upper face of the inkjet head 40 in the state illustrated in FIG. 9. In this case, it is a possible that the ridgeline 45a of the inkjet head 40 at the time of mounting is separated from the thermistor 50a and becomes contactless with the detection face 50ad of the thermistor 50a.

In view of this, in variation 2, a heat conductive sheet 50f is provided on the detection face 50ad of the thermistor 50a, as illustrated in FIG. 21B. The heat conductive sheet 50f includes a silicone sheet or the like that has a larger area than the area of the detection face. Accordingly, even when a situation has occurred where the ridgeline 45a of the inkjet head 40 at the time of mounting is separated from the thermistor 50a in the apparatus lateral direction (the lateral direction in FIG. 21B), the ridgeline 45a of the inkjet head 40 can abut onto the heat conductive sheet 50f. By doing this, head from the ridgeline 45a of the inkjet head 40 propagates via the heat conductive sheet 50f to the thermistor 50a at a high thermal conductivity. Thus, the thermistor 50a can detect the temperature of the ridgeline 45a of the inkjet head 40.

In variation 2, the heat conductive sheet 50f is disposed in such a way that a face of the heat conductive sheet 50f is inclined with respect to a mounting direction G of the inkjet head 40. Therefore, a mounting position of the ridgeline 45a of the inkjet head 40 is displaced in the apparatus lateral direction (the lateral direction in FIG. 21B), and a position where the ridgeline 45a abuts onto the heat conductive sheet 50f changes. This causes a change in an amount of the ridgeline 45a pressing the heat conductive sheet 50f. Stated another way, as the mounting position of the inkjet head 40 is closer to an inner wall face of a holder 80 serving as a head holder that a sheet end of the heat conductive sheet 50f is attached to, an amount of the ridgeline 45a pressing the heat conductive sheet 50f increases, and tension in the heat conductive sheet 50f increases.

Therefore, in variation 2, it is preferable that the heat conductive sheet 50f include a member having elasticity. By doing this, even when a mounting position of the ridgeline 45a of the inkjet head 40 is displaced in the apparatus lateral direction (the lateral direction in FIG. 21B) and an amount of the ridgeline 45a pressing the heat conductive sheet 50f increases, the heat conductive sheet 50f is extended, and tension is reduced. Thus, the heat conductive sheet 50f can be prevented from being damaged.

The heat conductive sheet 50f may be integral with the resin 50b covering the leads 50c and the thermistor 50a.

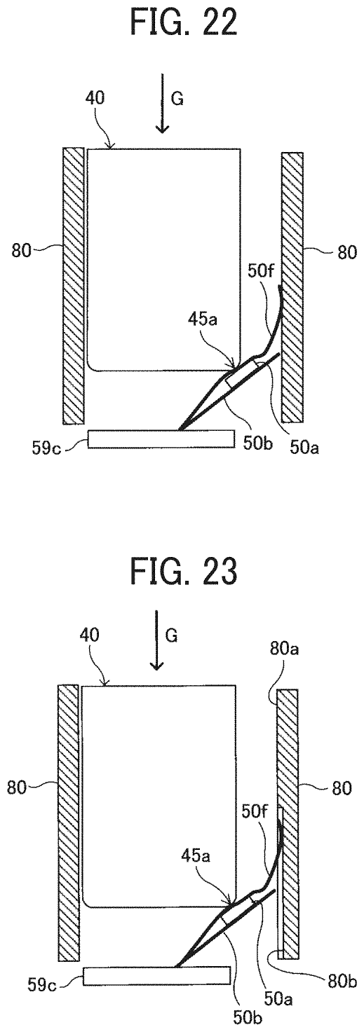

FIG. 22 is an explanatory diagram illustrating an example of a supporting configuration of the heat conductive sheet 50f.

In variation 2, in the heat conductive sheet 50f, one end is stuck on the detection face 50ad of the thermistor 50a, and the other end is stuck to the holder 80 serving as a head holder that holds the inkjet head 40. Thus, the heat conductive sheet 50f is supported. Therefore, both ends of the heat conductive sheet 50f can receive a pressing force from the ridgeline 45a of the inkjet head 40, and a high contact pressure between the ridgeline 45a of the inkjet head 40 and the heat conductive sheet 50f can be obtained.

FIG. 23 is an explanatory diagram illustrating another example of the supporting configuration of the heat conductive sheet 50f.

As illustrated in FIG. 23, the holder 80 includes an inner wall face portion 80a on the upstream side in the mounting direction of the inkjet head 40 (a direction indicated by arrow G in FIG. 23) and an inner wall face portion 80b downstream from the inner wall face portion 80a recessed from the inner wall face portion 80a. The inner wall face portion 80b is recessed from the inner wall face portion 80a by at least the thickness of the heat conductive sheet 50f. In this structure, as illustrated in FIG. 23, an end of the heat conductive sheet 50f supported by the holder 80 is attached to the inner wall face portion 80b. In this case, when the inkjet head 40 is mounted (or detached), the sheet end can be prevented from being caught by the inkjet head 40, and the heat conductive sheet 50f can be prevented from being peeled off from the holder 80.

Variation 3

Next, yet another variation of the head temperature sensor 50 according to the present embodiment (hereinafter, this variation is referred to as “variation 3”) is described.

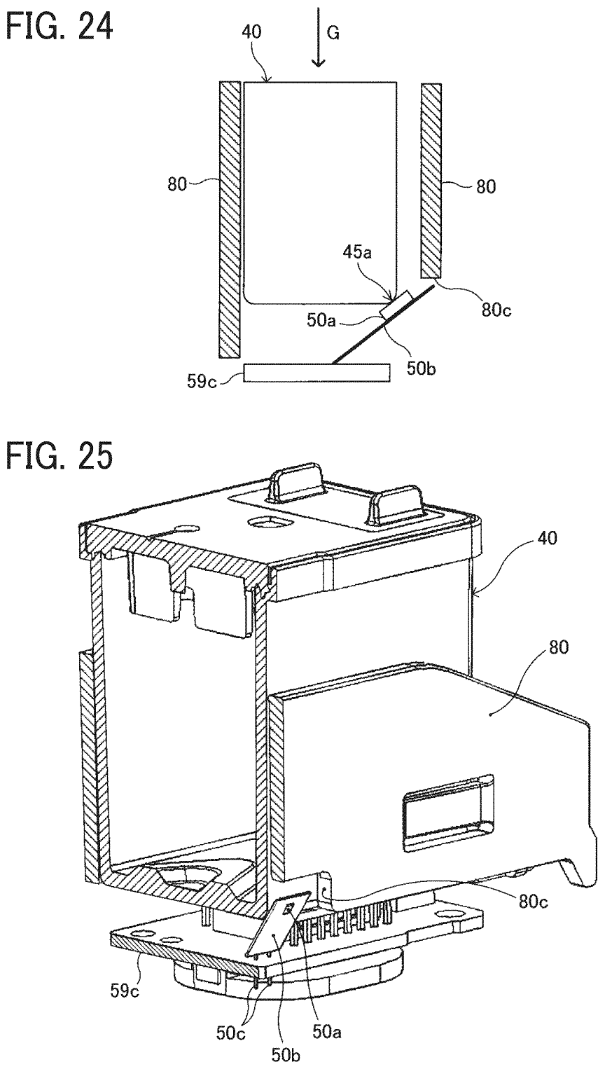

FIG. 24 is an explanatory diagram illustrating a supporting configuration of the head temperature sensor 50 in variation 3.

FIG. 25 is a perspective view in which the inkjet head 40 mounted in a holder has been cut o illustrate the head temperature sensor 50.

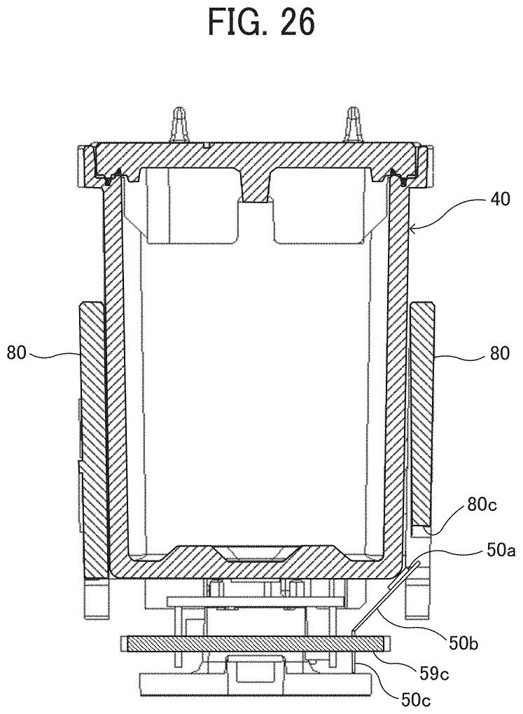

FIG. 26 is a cross-sectional view of the inkjet head 40 mounted in the holder.

In variation 3, an end of the resin 50b covering the thermistor 50a and the leads 50c is to be inserted into a notch 80c in the holder 80, as illustrated in FIG. 24. Therefore, when the thermistor 50a receives a pressing force from the ridgeline 45a of the inkjet head 40, the end of the resin 50b can be displaced inside the notch 80c of the holder 80, and the pressing force can be parried. Thus, an excessive contact pressure can be prevented from being generated between the ridgeline 45a of the inkjet head 40 and the thermistor 50a, and an appropriate contact pressure can be obtained.

Variation 4

Next, yet another variation of the head temperature sensor 50 according to the present embodiment (hereinafter, this variation is referred to as “variation 4”) is described.

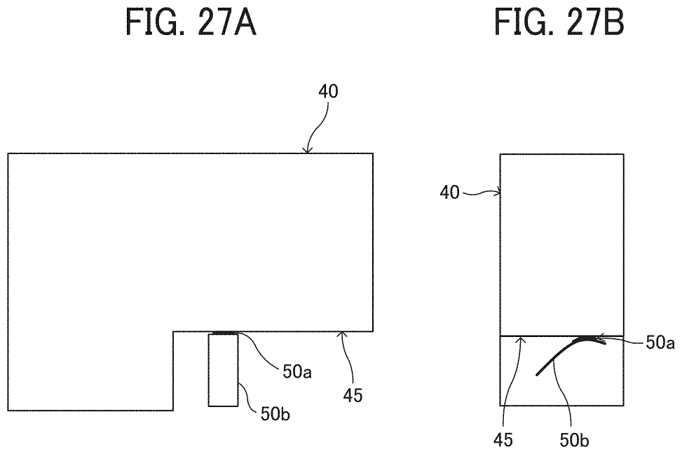

FIG. 27A is a side view illustrating a configuration of the head temperature sensor 50 in variation 4. FIG. 27B is a front view.

In variation 4, the resin 50b covering the thermistor 50a and the leads 50c has a curved shape, as illustrated in FIG. 27B, and the thermistor 50a has a curved shape following the curved shape of the resin 50b. In variation 4, the resin 50b is disposed so that a projecting curve of the thermistor 50a being curved contacts the sensor facing section 45 of the inkjet head 40. Stated another way, in variation 4, the curved face of the thermistor 50a in the curved state is made to contact the face of the inkjet head 40 (on the sensor facing section 45 side), so that line contact between the thermistor 50a and the inkjet head 40 is implemented.

In variation 4, similarly, the thermistor 50a can be brought into line contact with the inkjet head 40. Thus, a contact area is smaller than a contact area in the case of surface contact, and this results in a reduction in changes in the contact area between an inappropriate contact state and an appropriate contact state. Therefore, a difference is small between a detected temperature in the inappropriate contact state and a detected temperature in the appropriate contact state, and a variation in detected temperature can be reduced. Even in a situation where an inappropriate state of contact between the thermistor 50a and the inkjet head 40 constantly occurs, the detection of temperature has a small error, and temperature can be appropriately detected.

In the embodiment described above, an example has been described in which the present disclosure is applied to a handheld printer 10 of a handy mobile type serving as a portable image forming apparatus. However, a configuration according to the present disclosure can be applied to any apparatus that discharges liquid, and can also be applied to a stationary inkjet printer or the like.

The description above is an example, and an advantageous effect peculiar to each of the following aspects is exhibited.

First Aspect

A first aspect concerns a liquid discharge apparatus (for example, the handheld printer 10) that includes a liquid discharge head (for example, the inkjet head 40) to be detachably attached to an apparatus body (for example, a printer body 1). The liquid discharge apparatus includes a temperature detection device (for example, the head temperature sensor 50) that includes a temperature detector (for example, the thermistor 50a) disposed in the apparatus body. The temperature detector is brought into line contact with the liquid discharge head to detect temperature.

In a case where the temperature detector is to contact the liquid discharge head to detect temperature, normally, a detection face of the temperature detector is brought into surface contact with a face of the liquid discharge head in order to secure a large contact area, thereby reducing the error of the detection of temperature (difference between an actual temperature and a detected temperature). However, the liquid discharge head that is attachable to or detachable from the apparatus body generally has an error of a mounting position or a mounting posture, and the mounting position or the mounting posture varies. Accordingly, in some cases, the face of the liquid discharge head appropriately comes into surface contact with the detection face of the temperature detector. In other cases, the face of the liquid discharge head inappropriately comes into contact with the detection face of the temperature detector, for example, the face of the liquid discharge head is inclined with respect to the detection face of the temperature detector or the face of the liquid discharge head partially deviates from the detection face of the temperature detector. In such an inappropriate contact state, a contact area is significantly different from a contact area in an appropriate contact state. Therefore there is a significant difference between a detected temperature in the inappropriate contact state and a detected temperature in the appropriate contact state. As described above, in a configuration in which the temperature detector is brought into surface contact with the liquid discharge head to detect temperature, a state of contact between the temperature detector and the liquid discharge head varies due to a variation in a mounting position or a mounting posture, and a detected temperature significantly varies.

In the configuration in which the temperature detector is brought into surface contact with the liquid discharge head to detect temperature, in a situation where an inappropriate contact state between the temperature detector and the liquid discharge head constantly occurs (where there is an installation error of the temperature detector, or the like), the detection of temperature has a large error, and temperature is not appropriately detected.

In the present aspect, the temperature detector comes into line contact with the liquid discharge head. Thus, a contact area is smaller than a contact area in the case of surface contact, thereby reducing changes in the contact area between an inappropriate contact state and an appropriate contact state. Therefore, a difference is small between a detected temperature in the inappropriate contact state and a detected temperature in the appropriate contact state, and a variation in detected temperature can be reduced. Even in a situation where an inappropriate state of contact between the temperature detector and the liquid discharge head constantly occurs, the detection of temperature has a small error, and temperature can be appropriately detected.

In particular, for example, even in a case where the liquid discharge head is mounted in an inclined state so as to rotate around a line of line contact, a contact state that is similar to a contact state in a case where the liquid discharge head is mounted in a non-inclined state can be maintained. Thus, a variation in detected temperature can be reduced. Similarly, Similarly, even when the installation position of the temperature detector deviates (installation error) around the direction in which the line contact extends, a contact state that is similar to a contact state without any installation error can be maintained. Therefore, the detection of temperature has a small error, and temperature can be appropriately detected.

In a configuration in which the temperature detector comes into line contact with the liquid discharge head, a contact area is smaller than a contact area in the case of surface contact. Therefore, the accuracy of the detection of temperature is lower compared with the case of surface contact. The present aspect is based on a technical idea that aims at reducing variations in detected temperature even when the accuracy of the detection of temperature is slightly reduced, or ensuring temperature detection even in a situation where an inappropriate contact state constantly occurs.

Second Aspect

According to a second aspect, in the liquid discharge apparatus in the first aspect, the temperature detection device is configured such that the detection face (the detection face 50ad) of the temperature detector is to contact the ridgeline 45a of the liquid discharge head to detect temperature. This enables the use of a general temperature detector.

Third Aspect

A third aspect concerns the liquid discharge apparatus in the second aspect. Further, the ridgeline includes a ridgeline on a side of a liquid discharge side (the liquid discharge side LDS) of the liquid discharge head.

By doing this, in a configuration in which the liquid discharge head is pushed to the side of the discharge face to be mounted, line contact between the ridgeline on the liquid discharge head and the detection face of the temperature detector is easily implemented.

Fourth Aspect

A fourth aspect concerns the liquid discharge apparatus in the second or third aspect. Further, a heat conductive sheet (e.g., the heat conductive sheet 50f) is provided on the detection face of the temperature detector. The heat conductive sheet has an area that is larger than an area of the detection face.

By doing this, even when a situation has occurred where the ridgeline of the liquid discharge head at the time of mounting is separated from the detection face of the temperature detector, the ridgeline of the liquid discharge head can abut onto the heat conductive sheet. Therefore, heat from the ridgeline of the liquid discharge head propagates via the heat conductive sheet to the detection face of the temperature detector at a high thermal conductivity, and the temperature detector can detect the temperature of the ridgeline of the liquid discharge head.

Fifth Aspect

A fifth aspect concerns the liquid discharge apparatus in the fourth aspect. Further, the heat conductive sheet is supported by the detection face and a head holder (for example, a holder 80) that holds the liquid discharge head.

By doing this, both ends of the heat conductive sheet can receive a pressing force from the ridgeline of the liquid discharge head, and a high contact pressure between the ridgeline of the liquid discharge head and the heat conductive sheet can be obtained.

Sixth Aspect

Further, a sheet end of the heat conductive sheet supported by the head holder is attached to a downstream inner wall face (e.g., the 80b inner wall face portion) of the apparatus body (e.g., the printer body 1). The downstream inner wall face is recessed, by at least the thickness of the heat conductive sheet, from an upstream inner wall face (e.g., the inner wall face portion 80a) upstream from the downstream inner wall.

By doing this, when the liquid discharge head is mounted (or detached), the sheet end can be prevented from being caught by the liquid discharge head, and the heat conductive sheet can be prevented from being peeled off from the holder.

Seventh Aspect

A seventh aspect concerns the liquid discharge apparatus in any of the fifth and sixth aspects. Further, the heat conductive sheet has elasticity.

By doing this, even when a mounting position of the ridgeline of the liquid discharge head is displaced and an amount of the ridgeline pressing the heat conductive sheet increases, the heat conductive sheet can be extended, and tension can be reduced. The heat conductive sheet can be prevented from being damaged.

Eighth Aspect

An eighth aspect concerns the liquid discharge apparatus in any of the first to seventh aspects. Further, a temperature sensor (for example, the head temperature sensor 50) serving as the temperature detection device is mounted on a circuit board (e.g., the circuit board 59c) of a detection sensor (for example, the position detection sensor 59). The detection sensor is disposed in the apparatus body and is another detection device different from the temperature detection device.

By doing this, a circuit board for the temperature sensor that configures the temperature detection device does not need to be separately provided, and space can be saved.

Ninth Aspect

A ninth aspect concerns the liquid discharge apparatus in the eighth aspect, and the detection sensor includes a position detection sensor (e.g., the position detection sensor 59) configured to detect a position of the liquid discharge head relative to an object (for example, a recording medium P) to which the liquid discharge head discharges the liquid.

Such a position detection sensor is often installed near a discharge nozzle of the liquid discharge head. Therefore, the temperature of liquid near the discharge nozzle can be detected. Thus, for example, a detection result of the temperature detection device can be appropriately used in control in a case where the temperature of liquid at the time of discharge is controlled and in other cases.

Tenth Aspect

A tenth aspect concerns the liquid discharge apparatus in any of the first to ninth aspects. Further, even when a contact position is displaced in a direction orthogonal to a linear direction of the line contact, a contact length of the line contact does not change.

By doing this, even when the contact position is displaced in the direction orthogonal to the linear direction of the line contact, a contact state (a constant contact area) is maintained. Therefore, a variation in detected temperature can be reduced. Similarly, the detection of temperature has a small error, and temperature can be appropriately detected.

Eleventh Aspect

An eleventh aspect concerns the liquid discharge apparatus in any of the first to tenth aspects. Further, the liquid discharge apparatus includes a pressing member (for example, the pressure sponge 50e) configured to press the temperature detector to the liquid discharge head.

By doing this, due to the pressing force of the pressing member, appropriate line contact between the temperature detector and the liquid discharge head can be stably obtained.

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

What is claimed is:

1. A liquid discharge apparatus comprising:
an apparatus body;
a liquid discharge head configured to discharge a liquid and be removably attached to the apparatus body; and
a temperature detection device configured to detect a temperature of the liquid discharge head, the temperature detection device including a temperature detector disposed in the apparatus body and configured to be in line contact with the liquid discharge head.

2. The liquid discharge apparatus according to claim 1,
wherein a detection face of the temperature detector is to contact a ridgeline of the liquid discharge head, to detect the temperature of the liquid discharge head.

3. The liquid discharge apparatus according to claim 2,
wherein the ridgeline is on a liquid discharge side of the liquid discharge head.

4. The liquid discharge apparatus according to claim 2, further comprising a heat conductive sheet disposed on the detection face of the temperature detector, the heat conductive sheet greater in size than the detection face.

5. The liquid discharge apparatus according to claim 4,
wherein the apparatus body includes a head holder configured to hold the liquid discharge head, and
wherein the heat conductive sheet is supported by the detection face and the head holder.

6. The liquid discharge apparatus according to claim 5,
wherein the head holder includes an upstream inner wall face and a downstream inner wall face disposed downstream from the upstream inner wall face in a mounting direction of the liquid discharge head, the downstream inner wall face recessed from the upstream inner wall face by at least a thickness of the heat conductive sheet, and
wherein an end of the heat conductive sheet supported is attached to the downstream inner wall face of the head holder.

7. The liquid discharge apparatus according to claim 5,
wherein the heat conductive sheet has elasticity.

8. The liquid discharge apparatus according to claim 7, further comprising a detection sensor different from the temperature detection device and disposed in the apparatus body, the detection sensor including a circuit board,
wherein the temperature detection device is a temperature sensor and is mounted on the circuit board.

9. The liquid discharge apparatus according to claim 8,
wherein the detection sensor includes a position detection sensor configured to detect a position of the liquid discharge head relative to an object to which the liquid discharge head discharges the liquid.

10. The liquid discharge apparatus according to claim 1,
wherein a detection face of the temperature detector has such a shape that a length in a direction of the line contact is constant.

11. The liquid discharge apparatus according to claim 1, further comprising
a pressing member configured to press the temperature detector to the liquid discharge head.
